(19) United States
(12) Patent Application Publication
(10) Pub. No.: US 2026/0073211 A1
(43) Pub. Date: Mar. 12, 2026

(54) ALTERING MANIFOLDS FOR GENERATIVE MODELING

(71) Applicant: Microsoft Technology Licensing, LLC, Redmond, WA (US)

(72) Inventor: Harsh SHRIVASTAVA, Redmond, WA (US)

(73) Assignee: Microsoft Technology Licensing, LLC, Redmond, WA (US)

(21) Appl. No.: 18/826,664

(22) Filed: Sep. 6, 2024

(51) Int. Cl. G06N 3/08

(52) U.S. Cl. CPC G06N 3/08

(57) ABSTRACT

The present disclosure relates to systems and methods for modifying an output of a generative artificial intelligence (AI) model. The systems and methods control the loss function for samples under consideration by adjusting a value of the loss function for the samples and decreasing a probability that the generative AI model uses the samples in generating responses.

### BACKGROUND

Generative artificial intelligence (AI) models generate content, such as text, images, video, audio, or other data in response to a question or prompt. Generative AI models learn the patterns and structure of the input training data and generate new data that has similar characteristics to the input training data. Generative AI models respond to prompts by generating original content and are used in various industries.

### BRIEF SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Some implementations relate to a method. The method includes learning, by a neural network, an initial manifold over a dataset in response to the neural network performing manifold learning using a first loss function over the dataset. The method includes generating, by the neural network, samples in response to the neural network performing manifold sampling over the initial manifold. The method includes identifying a sample from the samples. The method includes including the sample in a second loss function. The method includes learning, by the neural network, a second manifold over the dataset in response to the neural network performing manifold learning using the second loss function over the dataset. The method includes generating, using the neural network, new samples in response to the neural network performing the manifold sampling over the second manifold.

Some implementations relate to a device. The device includes a memory to store data and instructions; and a processor operable to communicate with the memory, wherein the processor is operable to: learn, by a neural network, an initial manifold over a dataset in response to the neural network performing, using a first loss function, manifold learning over a dataset; generate, by the neural network, samples in response to the neural network performing manifold sampling over the initial manifold; identify a sample from the samples; include the sample in a second loss function; learn, by the neural network, a second manifold over the dataset in response to the neural network performing, using the second loss function, the manifold learning over the dataset; and generate, using the neural network, new samples in response to the neural network performing the manifold sampling over the second manifold.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for manifold learning and manifold sampling in accordance with implementations of the present disclosure.

FIG. 2 illustrates examples of single point manifolds in one dimension (1D) in accordance with implementations of the present disclosure.

FIG. 3 illustrates examples of multiple points manifolds in 1D in accordance with implementations of the present disclosure.

FIG. 4 illustrates examples of single point manifolds in two dimensions (2D) in accordance with implementations of the present disclosure.

FIG. 5 illustrates examples of multiple points manifolds in 2D in accordance with implementations of the present disclosure.

FIG. 6 illustrates an example graph of manifold loss with varying dimensions and varying number of points in accordance with implementations of the present disclosure.

FIG. 7 illustrates an example method for altering manifolds in accordance with implementations of the present disclosure.

FIG. 8 illustrates components that may be included within a computer system.

### DETAILED DESCRIPTION

This disclosure generally relates to modifying outputs of generative artificial intelligence (AI) models. Examples of generative AI models include Generative Pre-trained Transformer (GPT) models (e.g., GPT-3 or GPT-4), LLaMA, and GEMINI. Examples of generative AI models also include text-to-image models, such as, DALL-E. Generative AI models generate content, such as text, images, video, audio, or other data in response to a question or prompt. Generative AI models learn the patterns and structure of the input training data and generate new data that has similar characteristics to the input data in response to prompts.

Traditionally, during training of generative AI models, a cross-validation occurs of the training test data. The loss is minimized for the samples during the training process and the loss is assumed to be high for the unobserved data points or the loss is ignored in some cases. Occasionally errors occur during the training process of generative AI models resulting in incorrect outputs of the generative AI models.

One example error is incorrect data is used to train the generative AI models. For example, an image of cats is paired with the text horse instead of the text cats and the generative AI models incorrectly learns that the images of the cats are images of horses. The content generated by the generative AI models in response to a user's query or prompt about horses may be incorrect as a result of the errors that occurred during the training process.

Updates in knowledge may also occur after the generative AI models are trained resulting incorrect outputs of the generative AI models. Existing solutions include fine tuning to provide new data the generative AI models to help correct the output of generative AI models in response to errors that occurred during the training process. Existing solutions also update the data used to train the AI models to modify the output of the generative AI models.

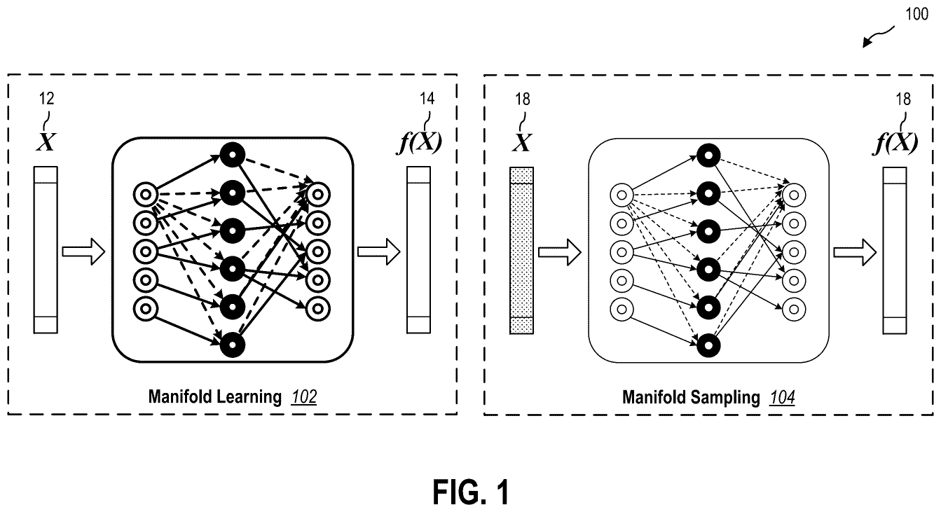

The present disclosure provides systems and methods for modifying an output of a generative AI model. For example, the generative AI model is a generative AI model as described in FIG. 1. The systems and methods of the present disclosure control the loss function for samples under consideration by adjusting a value of the loss function for the samples. The systems and methods introduce a new paradigm for training a generative AI model that increases the loss around identified samples of the generated data by the AI model. Increasing the loss changes the manifold of the loss for the identified samples, resulting in the generative AI model unlearning the samples. Unlearning the samples by the generative AI model provides a way to remove unwanted responses or outputs from the generative AI model. The present disclosure includes a number of practical applications that provide benefits and/or solve problems associated with modifying outputs of a generative AI model. Examples of these applications and benefits are discussed in further detail below.

The systems and methods learn a manifold on which the training data resides for a generative AI model, as described in FIG. 1. In machine learning, manifolds embed data. In some implementations, high dimensional data is embedded in a lower dimensional manifold and machine learning models try to learn the geometry of the manifold. Understanding a manifold helps a generative AI model generate high-fidelity samples. The systems and methods learn the probability distribution over the entire sampling space of the training data. In some implementations, the systems and methods use specially designed neural networks to learn the manifold over the training data. The systems and methods obtain samples from the learned neural network architectures using a gradient-based sampling. The samples may be any data represented by embeddings. For example, the samples include images. Another example of the samples include text. Another example of the samples include audio. Another example of the samples is video. The systems and methods introduce manifold trenches (which in turn, alters the probability during the sampling process) in the manifold of the neural network loss function.

The systems and methods identify a sample or subset of samples for the generative AI model to avoid. For example, the samples produce an undesired output of the generative AI model. Another example is the samples include incorrect data. The systems and methods modify the loss of the identified sample or subset of samples resulting in a modification of behavior (in terms of probability of the samples that can be generated) of the generative AI model. One example in a modification of behavior of the generative AI model includes unlearning the identified sample or subset of samples resulting in a change in content outputted by the generative AI model. Another example in a modification of behavior of the generative AI model includes avoiding the identified sample or subset of samples when generating content.

In some implementations, the systems and methods use a small number of samples to modify the loss and change the behavior of the generative AI model. For example, the loss is modified for a single sample resulting in a change in outputs provided by the generative AI model. Another example includes the loss is modified for three different samples resulting in a change of outputs provided by the generative AI model. Another example includes the loss is modified for samples within a range (e.g., samples within an input range of 0.5 to 0.7) resulting in modifications of outputs provided by the generative AI model. The systems and methods use a small number of samples without using all of the samples generated by the generative AI model.

In some implementations, the systems and methods increase the loss value of the samples or set of samples that are not valid or undesirable samples. By increasing the loss value, the negative datapoints have a low probability during the sampling process, resulting in the generative AI model avoiding the negative datapoints during sampling, achieving a desired alteration of the generative AI model.

In some implementations, the systems and methods introduce trenches in the manifold of the neural network loss to ensure the sampling process of the generative AI model processes samples close to the samples ensuring high-fidelity samples are obtained during the generative process.

One example use of the systems and methods of the present disclosure is during the training process of a generative AI model the training data accidentally paired images of cats with text saying the image is of a horse. The generative AI model is deployed, and a user provides a prompt to the generative AI model asking for images of horses and in response the generative AI model generates images of cats as the output using the training data of paired images of cats with the text horse. The samples of the images of cats with the horse text is identified using the systems and methods. The systems and methods increase the loss of the identified samples (images of cats with the horse text) so that the generative AI model excludes the identified samples when generating an output to the prompt asking for images of horses.

Another example use of the systems and methods of the present disclosure is avoiding sampling a subset of the training data. For example, the generative AI model is trained on images of animals and the user wants to avoid sampling images of cats by the generative AI model. The systems and methods increase the loss of the samples with images of cats so that the generative AI model avoids the samples with images of cats during the sampling process.

One technical advantage of the systems and methods of the present disclosure is improving the fidelity of the samples generated by the generative AI model (e.g., the generative AI model as described in FIG. 1). Another technical advantage of the systems and methods of the present disclosure is controlling the outputs of a generative AI model (e.g., the generative AI model as described in FIG. 1), so that the samples come from the desired regions. The systems and methods of the present disclosure change the output of a generative AI model without changing the entire behavior of the generative AI model (e.g., the generative AI model as described in FIG. 1). By unlearning a sample or a set of samples during the training process, the output of the generative AI model changes by changing the behavior of the generative AI model around the sample or the set of samples without modifying the entire behavior of the generative AI model. Another technical advantage of the systems and methods of the present disclosure is unlearning an undesired behavior of a generative AI model (e.g., the generative AI model as described in FIG. 1). Another technical advantage of the systems and methods of the present disclosure is updating a generative AI model after deployment of the generative AI model without retraining the entire generative AI model (e.g., the generative AI model as described in FIG. 1). Another technical advantage of the systems and methods of the present disclosure is updating the loss for a sample or set of samples in the training data resulting in a modification of an output of the generative AI model (e.g., the generative AI model as described in FIG. 1).

Referring now to FIG. 1, illustrated is an example environment 100 for manifold learning 102 and manifold sampling 104 for a neural network 10. In some implementations, the neural network 10 is a generative AI model that generates content, such as text, images, video, audio, or other data in response to a question or prompt. Generative AI models learn the patterns and structure of the input training data and generate new data that has similar characteristics to the training data in response to prompts. In some implementations, the neural network 10 is Generative Pre-trained Transformer (GPT) models (e.g., GPT-3 or GPT-4), LLaMA, and GEMINI. In some implementations, the neural network 10 is a Multilayer Perceptron neural network. In some implementations, the neural network 10 is a Convolutional Neural Network. In some implementations, the neural network 10 is a transformer based architecture. In some implementations, the neural network 10 is a neural graphical model. In some implementations, the environment 100 is used for domains with data paucity.

The neural network 10 performs manifold learning 102 over a set of input data 12. Manifold learning 102 is a process of learning by the neural network 10 to learn weights based on the input data 12 to adjust the deep learning architecture of the neural network 10 and obtain a good fit for a loss function. In some implementations, the neural network 10 minimizes the loss function during the manifold learning 102 process. An example loss function that the neural network 10 learns during the manifold learning 102 process is illustrated in equation (1):

$$( {ℒ}_{Base} ) {min}_{f 𝒩} \frac{1}{M \cdot D} {\sum }_{i}^{M} {‖ {X}^{( i )} - f 𝒩 ( {X}^{( i )} ) ‖}_{2}^{2} \qquad ( 1 )$$

where the deep learning architecture (f_{N}) of the neural network 10 operates on a set X∈R^{M×D} with M samples of D dimensions each. The neural network 10 minimizes the loss function of equation (1). The equation (1) divides by D, so that the maximum loss value is 1, since the ‘Sigmoid’ applied at the output restricts the values between (0, 1). The input data 12 is reconstructed at the model output 14 during the manifold learning 102 process.

During the manifold learning 102 process, the neural network 10 learns a manifold of the input samples. The manifold is a function. One example of visualizing the manifold learned by the neural network 10 is a loss function of equation (1) versus the input samples.

During manifold learning 102, the neural network 10 learns the probability distribution over the entire input data 12. In some implementations, the manifold learning 102 process is learning a probability density function over the input data 12 as illustrated in equation (2) below.

$$p ( X ) ∝ {e}^{- {‖ x - f 𝒩 ( X ) ‖}_{2}^{2}} \qquad ( 2 )$$

During manifold sampling 104 (the generative process of the neural network 10), the input data 16 is a learnable tensor while the weights of the neural network 10 are frozen (based on the weights learned during the manifold sampling 104 process). The input data 16 is optimized to match the model output 18. The learned model weights for the neural network 10 are fixed and the neural network 10 tunes the input data 16 (e.g., an input tensor) to match the model output 18. In some implementations, the neural network 10 uses equation (3) during the manifold sampling 104 process to optimize the loss so that the input tensor matches the model output 18:

$$arg {min}_{X} \frac{1}{D} {‖ \hat{X} - f 𝒩 ( \hat{X} ) ‖}_{2}^{2} \qquad ( 3 )$$

where the input learnable tensor X^{\hat{ }} is initialize randomly, for instance, from a Gaussian distribution ˜N (0, I).

In some implementations, the neural network 10 alters the manifolds for samples of data to use during the manifold learning 102 process. Altering the manifolds allows the neural network 10 to unlearn samples when the neural network 10 generates content in response to a query or prompt. For example, noisy or low-fidelity samples are identified in response to running the manifold learning 102 and the manifold sampling 104. One example of noisy samples or low-fidelity samples are samples obtained from an undesired region (e.g., the samples do not represent a generalization of the training data). Another example of noisy samples or low-fidelity samples are samples where the visual quality of the samples is low. In addition, altering the manifolds allows the neural network 10 to perform multi-modal generative AI tasks.

In some implementations, the neural network 10 increases the loss value for the sample or set of samples identified as noisy or undesirable. By increasing the loss value for the identified sample or set of samples, the neural network 10 is modeling to avoid the negative datapoints so that the undesirable the undesirable sample or set of samples have a very low probability of the learned manifold.

Increasing the loss value for the identified samples or set of samples, the overfitting capability and the high complex functional representation power of the neural network 10 is leveraged to achieve the desired alteration of the learned manifold. Increasing the loss value for the identified samples or set of samples also introduces trenches in the manifold of the neural network 10 loss function. Manifold trenches ensures that the during the manifold sampling 104 process by the neural network 10, the samples are close enough to the samples ensuring high-fidelity samples are obtained during the generative process by the neural network 10. For example, in image generation, high-fidelity samples are samples that visually look good. One example of a high-fidelity sample includes a high-fidelity molecule sample with a valid molecule structure that occurs naturally or can be synthesized in a lab.

One example equation that the neural network 10 uses to alter the manifolds of the identified sample or set of samples is illustrated below in equation (4).

$$( {ℒ}_{AltMan} ) {min}_{f 𝒩} \frac{1}{( {M}_{tr} ) \cdot D} {\sum }_{i}^{M} {‖ {X}_{tr}^{( i )} - f 𝒩 ( {X}_{tr}^{( i )} ) ‖}_{2}^{2} - \frac{1}{( {M}_{alt} ) \cdot D} {\sum }_{i}^{M} {‖ {X}_{alt}^{( i )} - f 𝒩 ( {X}_{alt}^{( j )} ) ‖}_{2}^{2} \qquad ( 4 )$$

The second term in the equation (4) ensures that the loss is high (or the input and output does not match) for the points X_{AltMan}, thus marking the region with a lower probability in order to avoid sampling from the region by the neural network 10. The loss function in equation (4) is bounded by limiting the output of the neural network 10 by using a ‘Sigmoid’ layer. Equation (4) artificially introduces local minimas at the observed input data points (the identified samples), so that optimizing the neural network 10 harnesses a drawback of neural network 10 getting stuck in the local minima.

In some implementations, the neural network 10 performs manifold learning 102 on a single data point in 1D (e.g., a single sample). In some implementations, the neural network 10 performs manifold learning to two data points in 1D (e.g., two samples). Any number of samples may be used during the manifold learning 102. As the number of data points (e.g., the number of samples) used in manifold learning 102 increases, the loss function values in general decrease throughout. Or the average loss value of the entire manifold (e.g., the loss over the whole input range and not just the training data) decreases with the increase in number of points.

In some implementations, the neural network 10 performs manifold learning 102 on a single point in 2D (e.g., a single sample in 2 dimensions). In some implementations, the neural network 10 performs manifold learning 102 on multiple points in 2D (e.g., multiple samples in 2 dimensions). The points in higher dimensions are also connected by flat hyperplanes that have similar loss function value. The neural network 10 hyperplane creates a ‘dimple’ (or a dip, or a small trench) around the training data points when using the equation (1) for manifold learning 102. With a slight change in the weights of the neural network 10, the output of the neural network 10 can change for a given input data point. As the loss function curve is relatively flat, there is not much loss difference between the observed (training) and the unobserved (testing) data points when using the equation (1) for manifold learning 102. A smooth manifold dip is formed at the training points when using the equation (1) for manifold learning 102.

In some implementations, the neural network 10 performs manifold learning 102 in higher dimensions and identifies the noisy or low-fidelity samples. The identified samples (e.g., the noisy or low-fidelity samples), are included as part of the alteration set (Xₐₗₜₑᵣ in equation (4)) and are marked for unlearning by modifying the manifolds at the identified samples using equation (4). The process continues until all of the noisy or low-fidelity samples are unlearned by the neural network 10, introducing deeper manifold trenches around samples.

In some implementations, the pairwise mean vectors over the entire training dataset are calculated and the pairwise mean vectors is used at the alteration set (Xₐₗₜₑᵣ in equation (4)). The equation 4 trains the neural network 10 to unlearn the alteration set (Xₐₗₜₑᵣ) by reducing the probability of sampling the points in the alteration set by the neural network 10. Introducing manifold trenches using equation (4) leads to higher fidelity samples.

In some implementations, the neural network 10 alters the manifolds by making slight modifications to the input to increase the loss value of the input using equation (4). The training data point is pulled out from the manifold dip and gets misclassified in response to altering the manifold. The manifold is altered so that the loss difference between the training data and a random point in the data space is quite high helping to prevent adversarial attacks on the neural network 10. Adversarial attacks typically try to trick a model by slightly changing the input. Altering the manifolds requires a considerable retraining of the weights of the neural network 10 to alter the output the neural network 10 for a given input, making adversarial attacks difficult on the neural network 10.

In some implementations, one or more computing devices (e.g., servers and/or devices) are used to perform the processing of the environments 100. The one or more computing devices may include, but are not limited to, server devices, cloud virtual machines, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the neural network 10 is implemented on a single computing device. Moreover, in some implementations, one or more subcomponent of the feature and functionalities discussed herein may be implemented are processed on different server devices of the same or different cloud computing networks. For example, the neural network 10 is implemented on different server devices.

In some implementations, each of the components of the environment 100 is in communication with each other using any suitable communication technologies. In addition, while the components of the environment 100 are shown to be separate, any of the components or subcomponents may be combined into fewer components, such as into a single component, or divided into more components as may serve a particular implementation. In some implementations, the components of the environment 100 include hardware, software, or both. For example, the components of the environment 100 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 100 include hardware, such as a special purpose processing device to perform a certain function or group of functions. In some implementations, the components of the environment 100 include a combination of computer-executable instructions and hardware.

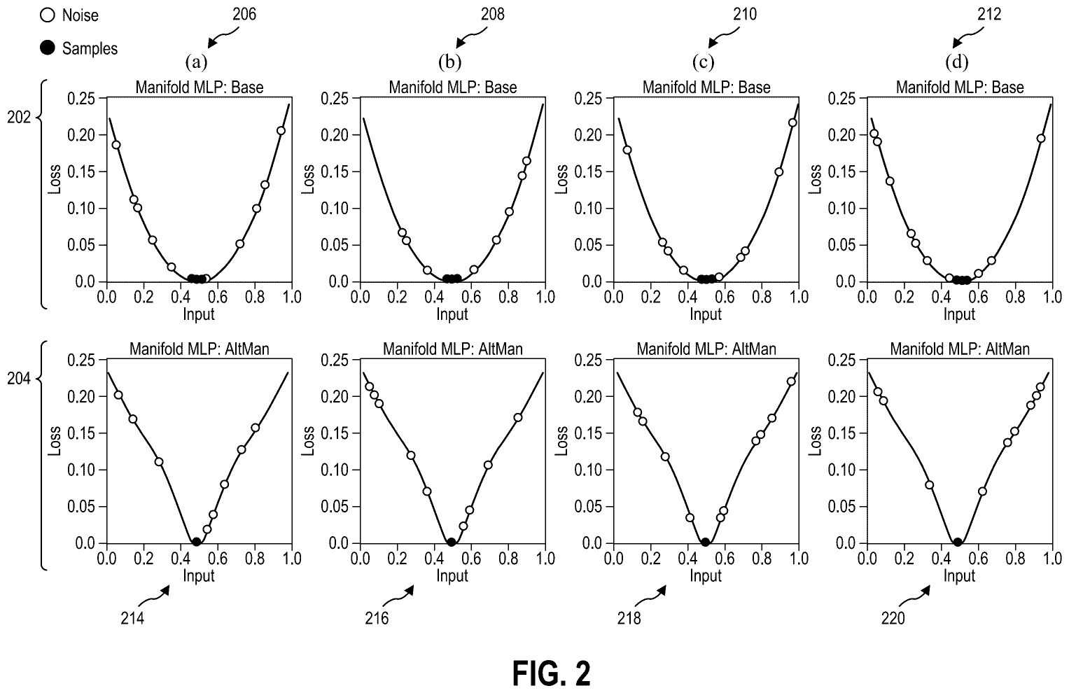

FIG. 2 illustrates examples of single point manifolds in 1D. The graphs 206, 208, 210, 212, 214, 216, 218, 220 illustrate the neural network 10 (FIG. 1) performing manifold learning 102 (FIG. 1) on a single input point x=0.5, where the range of x∈(0, 1). The initial noise (10 points) that results from the manifold learning 102 is shown along the curve of the graphs 206, 208, 210, 212, 214, 216, 218, 220. The graphs 206, 208, 210, 212, 214, 216, 218, 220 also illustrate the neural network 10 performing manifold sampling 104 (FIG. 1). The recovered samples that result from the manifold sampling 104 are shown at the base of the curve of the graphs 206, 208, 210, 212, 214, 216, 218, 220. In some implementations, the curve of the graphs 206, 208, 210, 212, 214, 216, 218, 220 gives insights into the underlying manifold structure helping predict the manifold structure. The loss value is illustrated on the y-axis and the input is illustrated on the x-axis in the graphs 206, 208, 210, 212, 214, 216, 218, 220. Visualizing loss versus input (e.g., in the graphs 206, 208, 210, 212, 214, 216, 218, 220) helps predict the manifold structure.

In the illustrated example, the neural network 10 is a MLP with increasing complexity moving from column (a) to (d) with ‘ReLU’ as the non-linearity in the middle layers and an entry wise ‘Sigmoid’ in the final layer. Column (a) has MLP with number of hidden layer L=1 with hidden units H=2, (b) L=1, H=10, (c) L=2, H=10 & (d) L=4, H=10. The manifold training on the neural network 10 was done until the loss on the input data point was low (≤1e-8, epochs ≥2K), in other words, overfitting the MLP to the input data.

The top row 202 of graphs 206, 208, 210, 212 illustrates the neural network 10 using the equation (1) (FIG. 1) for the manifold learning 102 process. The neural network 10 in graphs 206, 208, 210, 212 performs undesirable behaviors by sampling before and after the input point x=0.5. For example, the neural network 10 is sampling at 0.4 and 0.6 and the neural network 10 and remains in regions that are undesired using the equation (1).

The bottom row 204 of graphs 214, 216, 218, 220 illustrates the neural network 10 altering the manifolds using the equation (4) (FIG. 1) for the manifold learning 102 process, which is trained to exclude the extreme points {0, 1}. The loss value is close to 1 at the extreme points and the loss value creates trench at the data point x. The curve of the graphs 214, 216, 218, 220 is steeper in response to altering the manifolds and the neural network 10 unlearning the samples at 0.4 and 0.6, for example. In addition, altering the manifolds and increasing the loss of the undesirable regions (e.g., 0.4 and 0.6) using the equation (4), creates a manifold trench at the input x=0.5 which allows the neural network 10 to achieve better samples by sampling in the region closer to 0.5.

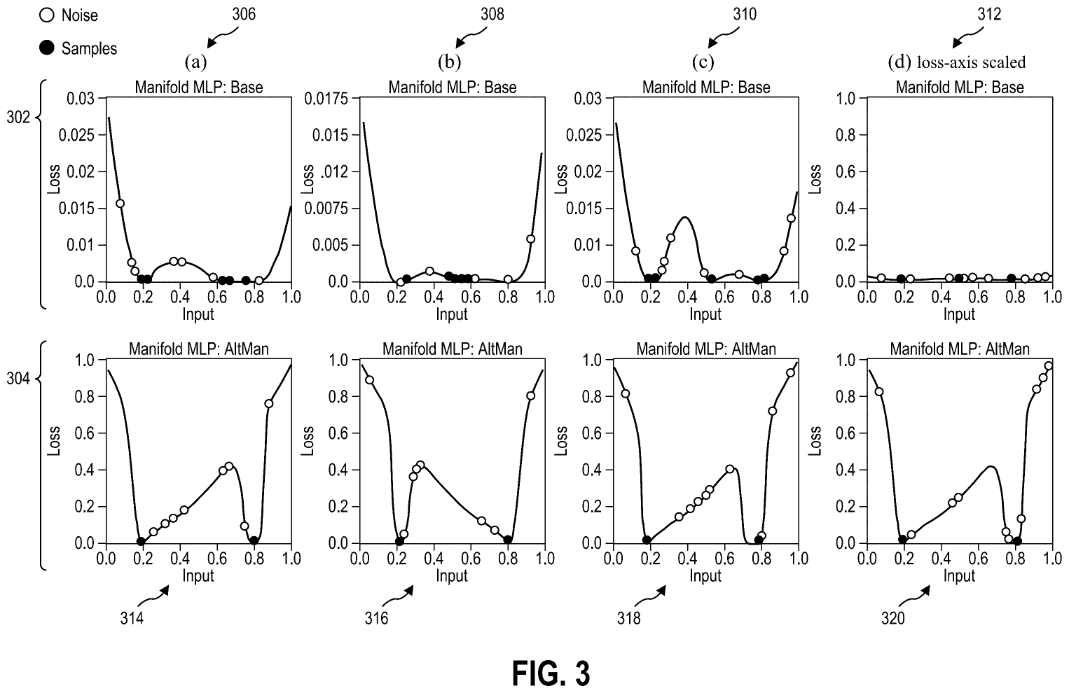

FIG. 3 illustrates multiple points manifolds in 1D. The graphs 306, 308, 310, 312, 314, 316, 318, 320 illustrate the neural network 10 (FIG. 1) performing manifold learning 102 (FIG. 1) on two data points {0.2, 0.8}. The initial noise (10 points) that results from the manifold sampling 104 is shown along the curve of the graphs 306, 308, 310, 312, 314, 316, 318, 320 and the recovered samples are shown at the base of the curve of the graphs 306, 308, 310, 312, 314, 316, 318, 320. In some implementations, the curve of the graphs 306, 308, 310, 312, 314, 316, 318, 320 gives insights into the underlying manifold structure helping predict the manifold structure. The loss value is illustrated on the y-axis and the input is illustrated on the x-axis in the graphs 306, 308, 310, 312, 314, 316, 318, 320. Visualizing loss versus input (e.g., in the graphs 306, 308, 310, 312, 314, 316, 318, 320) helps predict the manifold structure.

In the illustrated example, the neural network 10 is a MLP with increasing complexity moving from column (a) to (d) with ‘ReLU’ as the non-linearity in the middle layers and an entry wise ‘Sigmoid’ in the final layer. The column (a) fits a MLP with a number of hidden layers of L=2, with hidden units H=10, (b) L=2, H=50, (c) L=4, H=50, and (d) L=4, H=50.

The top row 302 of graphs 306, 308, 310, 312 illustrates the neural network 10 using the equation (1) (FIG. 1) for the manifold learning 102 process. In the graphs 306, 308, 310, 312, the loss function is relatively flat between 0.2 to 0.8, causing the sampling procedure of the neural network 10 to get samples from anywhere within this large range, resulting in undesired behavior of the neural network 10.

The bottom row 304 of graphs 314, 316, 318, 320 illustrates the neural network 10 altering the manifolds using the equation (4) (FIG. 1) for the manifold learning 102 process. The altering manifold technique includes training the Neural network 10 to exclude the extreme points {0, 1} and the middle point {0.5} so that the loss function is not flat between 0.2 to 0.8 and a trench is formed at the points of interest (0.2 and 0.8). In some implementations, the altering manifold technique increases the loss at the middle point 0.5 to cause a trench at the points of interest, 0.2 and 0.8. Altering the manifolds generates samples by the neural network 10 closer to the desired region (e.g., 0.2 and 0.8) with higher probabilities, resulting in improved sampling by the neural network 10.

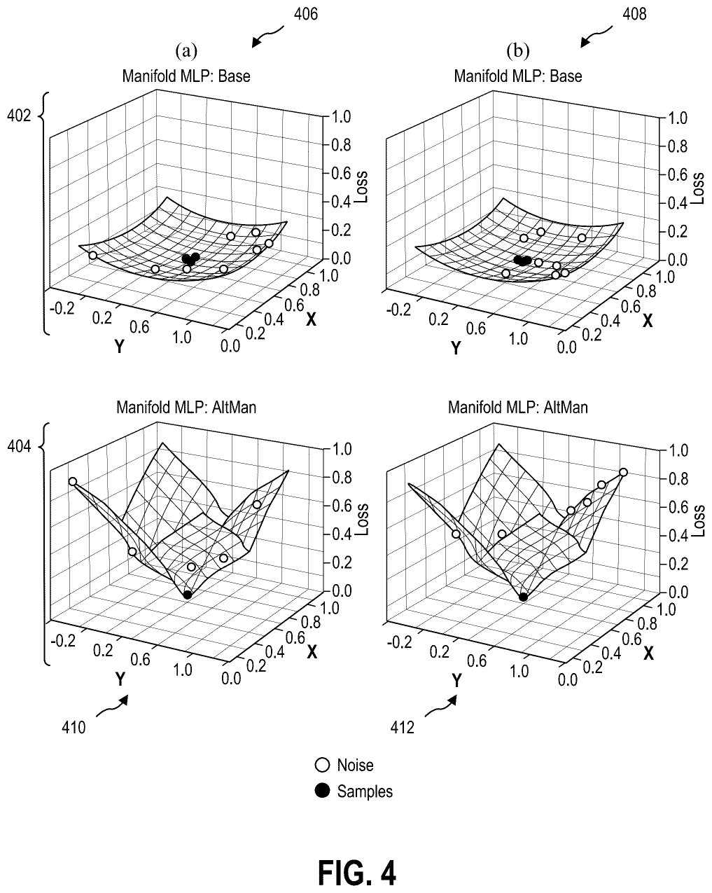

FIG. 4 illustrates examples of single point manifolds in two dimensions (2D). The graphs 406, 408, 410, 412 illustrate the neural network 10 (FIG. 1) performing manifold learning 102 (FIG. 1) in 2D at point x=(0.5, 0.5). Each plot initializes a uniformly sampled random noise (10 points) that is shown along the curve of the graphs 406, 408, 410, 412. The graphs 406, 408, 410, 412 also illustrate the neural network 10 performing manifold sampling 104 (FIG. 1). The samples that result from the manifold sampling 104 are shown at the base of the curve of the graphs 406, 408, 410, 412. In some implementations, the curve of the graphs 406, 408, 410, 412 gives insights into the underlying manifold structure helping predict the manifold structure. The loss value is illustrated on the y-axis and the input is illustrated on the x-axis in the graphs 406, 408, 410, 412. Visualizing loss versus input (e.g., in the graphs 406, 408, 410, 412) helps predict the manifold structure.

In the illustrated example, the neural network 10 is a MLP with increasing complexity moving from column (a) to (b) with ‘ReLU’ as the non-linearity in the middle layers and an entry wise ‘Sigmoid’ in the final layer. The column (a) fits a MLP with hidden layers of L=1, with hidden units H=10 and (b) L=2, H=10.

The top row 402 of graphs 406, 408 illustrates the neural network 10 using the equation (1) (FIG. 1) for the manifold learning 102 process. In the graphs 406, 408, the loss function value is relatively flat compared to the loss function using the altering manifold illustrated in graphs 410, 412, causing the sampling procedure by the neural network 10 during the manifold sampling 104 (FIG. 1) to draw samples from relatively distant regions from the input as the loss is inversely proportional sampling probability, as illustrated in equation (2) (FIG. 1).

The bottom row 404 of graphs 410, 412 illustrates the neural network 10 altering the manifolds using the equation (4) (FIG. 1) for the manifold learning 102 process. The altering manifold technique includes training the Neural network 10 to avoid extremities of the manifold (e.g., xₐₗₜₑᵣ=[(0, 0), (0, 1), (1, 0), (1, 1)] to increase the loss at (0, 0), (0, 1), (1, 0), (1, 1)), while minimizing loss at the input data point x=(0.5, 0.5). The altering manifold technique results in trenches at the point x=(0.5, 0.5) and the neural network 10 generating samples closer to the input data point x=(0.5, 0.5), resulting in improved sampling by the neural network 10.

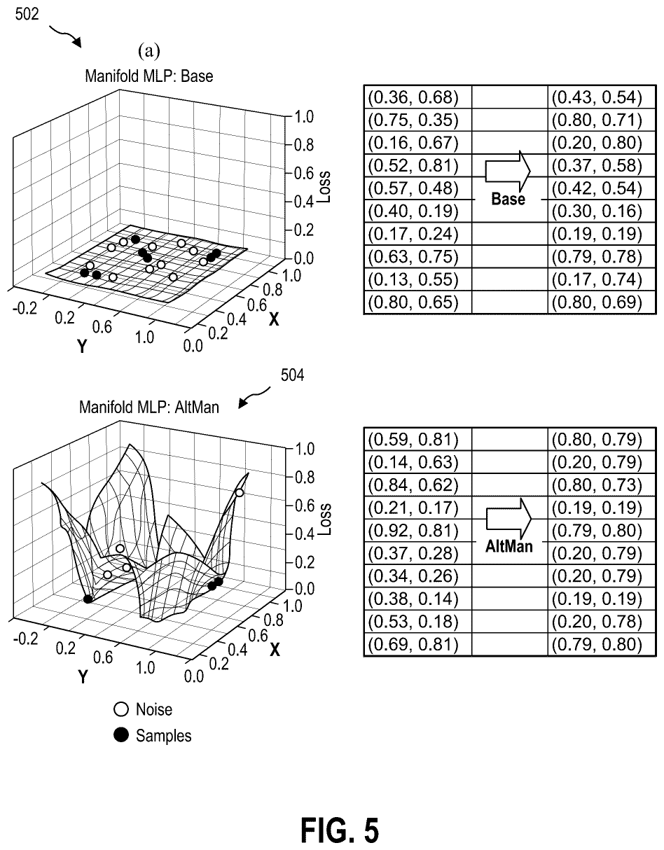

FIG. 5 illustrates examples of multiple points manifolds in 2D. The graphs 502, 504, illustrate the neural network 10 (FIG. 1) performing manifold learning 102 (FIG. 1) in 2D at the points x=[(0.2, 0.2), (0.2, 0.8), (0.8, 0.2), (0.8, 0.8)]. Each plot initializes a uniformly sampled random noise (10 points) that is shown along the curve of the graphs 502, 504. The graphs 502, 504 also illustrate the neural network 10 performing manifold sampling 104 (FIG. 1) and the samples that result from the manifold sampling 104. In some implementations, the curve of the graphs 502, 504 gives insights into the underlying manifold structure helping to predict the manifold structure. The loss value is illustrated on the y-axis and the input is illustrated on the x-axis in the graphs 502, 504. Visualizing loss versus input (e.g., in the graphs 502, 504) helps predict the manifold structure. In the illustrated example, the neural network 10 is a MLP with ‘ReLU’ as the non-linearity in the middle layers and an entry wise ‘Sigmoid’ in the final layer. The MLP has hidden layers of L=3, with hidden units H=10.

The top row with the graph 502 illustrates the neural network 10 using the equation (1) (FIG. 1) for the manifold learning 102 process. In the graph 502, the loss function hyperplane is relatively flat compared to the loss function using the altering manifold illustrated in the graph 504 causing the sampling procedure by the neural network 10 during the manifold sampling 104 (FIG. 1) to draw samples from relatively distant regions from the input as illustrated in column (b).

The bottom row with the graph 504 illustrates the neural network 10 altering the manifolds using the equation (4) (FIG. 1) for the manifold learning 102 process. The altering manifold technique includes training the Neural network 10 to avoid extremities of the manifold (e.g., xₐₗₜₑᵣ=[(0, 0), (0, 1), (1, 0), (1, 1)] to increase the loss at (0, 0), (0, 1), (1, 0), (1, 1)), while minimizing loss at the input data points x=[(0.2, 0.2), (0.2, 0.8), (0.8, 0.2), (0.8, 0.8)]. The altering manifold technique results in trenches at the input points x=[(0.2, 0.2), (0.2, 0.8), (0.8, 0.2), (0.8, 0.8)] and the neural network 10 generating samples closer to the input data points x=[(0.2, 0.2), (0.2, 0.8), (0.8, 0.2), (0.8, 0.8)], resulting in improved sampling by the neural network 10.

In some implementations, the information from column (b) is used to identify additional input points to alter the manifold. For example, consider the row 3 for the graph 504, (0.84, 0.62)→(0.80, 0.73). The recovered samples should have been closer to the desired point (0.8, 0.8) in response to altering the manifolds. However, a groove along the y-axis at x ˜0.8 caused the sampling algorithm of the neural network 10 to stop as the loss gradient is quite less. If an alteration point around (0.8, 0.5) is included in the equation (4), the loss slope would be steeper, and the sample tumbles down towards the desired point (0.8, 0.8). Such analysis using the information from column (b) provides insights about the trenches, valleys and, in general, the profile of the hyperplane.

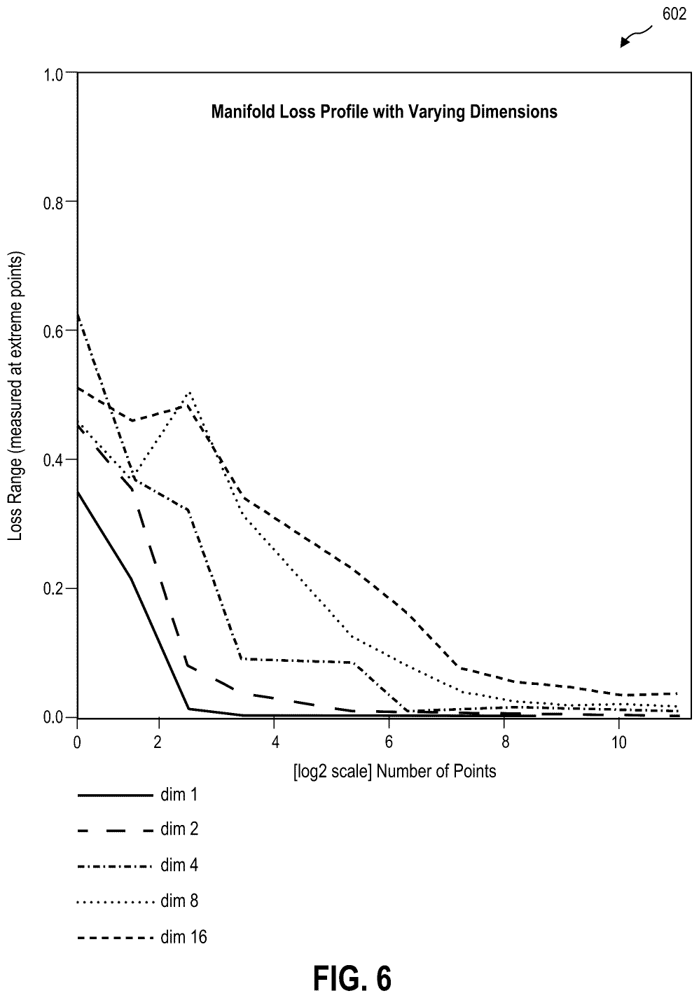

FIG. 6 illustrates an example graph 602 of manifold loss with varying dimensions and varying number of points. For a given dimension D, there are 2^{D} extreme points. For example, if the space is R⁴, the extreme points of the space are [(0, 0), (0, 1), (1, 0), (1, 1)]. The loss range is illustrated on the y-axis and the input points is illustrated on the x-axis in the graph 602. Some points are initialized uniformly at random on the R^{D} space and manifold learning 102 (FIG. 1) is run on the neural network 10 (FIG. 1) until convergence occurs (e.g., minimum loss ˜0).

On the x-axis of the graph 602, the number of training points which are chosen as powers of 2, from 2⁰→2¹¹ are plotted. In the illustrated example, the neural network 10 chosen is a MLP with L=2, H=50. To get the loss range, the loss of the MLP is evaluated at the extreme points of the space and the max loss value is chosen. For R¹⁶ space, the loss is evaluated at 2¹¹=65536 extreme points. If the number of training points are large, then no matter the dimension of the input space, the manifold learned by the neural network 10 using the equation (1), becomes flat with respect to the loss value.

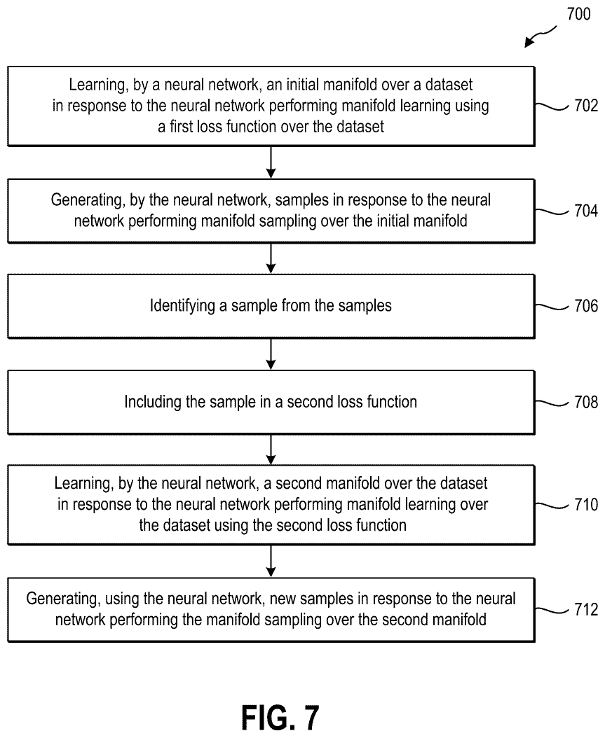

FIG. 7 illustrates an example method 700 for altering manifolds of a neural network 10 (FIG. 1). In some implementations, the neural network 10 is a generative AI model that generates content, such as text, images, video, audio, or other data in response to a question or prompt. The actions of the method 700 are discussed below in reference to FIGS. 1-6.

At 702, the method 700 includes learning, by a neural network, an initial manifold over a dataset in response to the neural network performing manifold learning using a first loss function over the dataset. The neural network 10 learns an initial manifold over a dataset in response to performing manifold learning 102 using a first lost function over the dataset. During the manifold learning 102 process, the neural network 10 learns weights based on the input data 12 to adjust the deep learning architecture of the neural network 10 to obtain a good fit for a loss function. In some implementations, the neural network 10 minimizes the loss function during the manifold learning 102 process. In some implementations, the first lost function is equation (1).

During manifold learning 102, the neural network 10 learns the probability distribution over the entire input data 12 and the neural network 10 learns an initial manifold of the input samples. In some implementations, the initial manifold is a function of the first loss function (e.g., the equation (1)) versus the dataset. In some implementations, the manifold learning occurs in dimensions higher than 1D.

At 704, the method 700 includes generating, by the neural network, samples in response to the neural network performing manifold sampling over the initial manifold. The neural network 10 performs manifold sampling 104 over the initial manifold and generates samples in response to performing the manifold sampling 104. In some implementations, the manifold sampling 104 occurs in dimensions higher than 1D.

At 706, the method 700 includes identifying a sample from the samples. In some implementations, the sample is identified in response to the neural network 10 performing manifold sampling 104 over the initial manifold. In some implementations, the sample is an unwanted output of the neural network. In some implementations, the sample is in a region a distance from samples coming from the underlying distribution of input data. For example, samples coming from the underlying distribution of input data are samples outputted by the neural network 10 that are similar to the input data 16. In some implementations, as the distance increases from the input data, samples generated by the neural network in the distance are out of distribution samples (e.g., unwanted samples). One example of an unwanted sample is a sample that is noisy. Another example of an unwanted sample is a sample that is low fidelity. One example of an unwanted sample is a sample that is dissimilar to the input data 16 distribution. Another example of an unwanted sample is a sample with incorrect information. In some implementations, a set of samples are identified, and the set of samples are included in the second loss function. The set of samples are in a region or regions a distance from samples of interest.

At 708, the method 700 includes including the sample in a second loss function. The second loss function increases the loss for each sample or the set of samples reducing a probability that the neural network 10 generates the new samples from the sample or the set of samples. In some implementations, the second loss function is equation (4). In some implementations, the second loss function increases a loss for a set of samples. By increasing the loss value for the identified sample or set of samples, the neural network 10 is modeling to avoid the negative datapoints so that the undesirable the undesirable sample or set of samples have a very low probability of the learned manifold.

At 710, the method 700 includes learning, by the neural network, a second manifold over the dataset in response to the neural network performing manifold learning over the dataset using the second loss function. In some implementations, the second manifold is a function of the second loss function (e.g., equation 4) versus the dataset. In some implementations, the neural network 10 alters the manifolds for samples of data during the manifold learning 102 process. Altering the manifolds allows the neural network 10 to unlearn samples when the neural network 10 generates content in response to a query or prompt. In addition, altering the manifolds allows the neural network 10 to perform multi-modal generative AI tasks.

At 712, the method 700 includes generating, using the neural network, new samples in response to the neural network performing the manifold sampling over the second manifold. The neural network 10 generates new samples in response to performing the manifold sampling 104 over the second manifold. In some implementations, the new samples are closer in distance to the input data as compared to the sample identified in the region. For example, the new samples are generated in a region nearby the input data 16. In some implementations, the second loss function increases a loss for the sample decreasing a probability that the neural network 10 generates the new samples using the sample.

In some implementations, the second manifold increases a trench at an input data point in the dataset on the second manifold increasing a probability that the neural network generates the new samples from a region surrounding the trench. In some implementations, the second loss function increases a loss of the sample and removes the sample from the region surrounding the trench in the second manifold. The neural network 10 generates the new samples from the region surrounding trench at the input data point.

In some implementations, a plurality of input data points is identified in the dataset and the second manifold increases trenches in the second manifold, where each trench corresponds to an input data point of the plurality of data points. The trenches increase a probability that the neural network 10 generates the new samples from regions surrounding the trenches. In some implementations, the second loss function increases a loss of the sample and removes the sample from the regions surrounding the trenches, reducing the probability that the neural network generates the new samples from the sample.

The method 700 updates the loss for a sample or set of samples resulting in a modification of an output of the generative AI model. The method 700 improves the samples used by a generative AI model by altering the manifolds of identified samples by increasing a loss of the identified samples. Increasing the loss of the identified samples, aids the AI model in unlearning the identified samples and improving new content generated by the AI model.

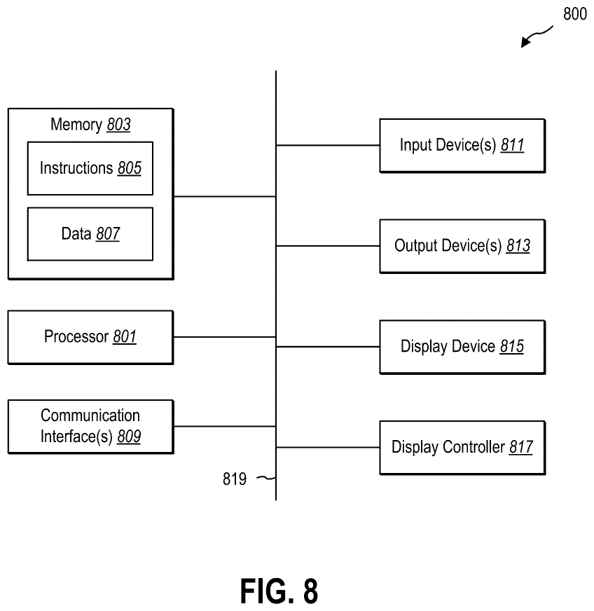

FIG. 8 illustrates components that may be included within a computer system 800. One or more computer systems 800 may be used to implement the various methods, devices, components, and/or systems described herein.

The computer system 800 includes a processor 801. The processor 801 may be a general-purpose single or multi-chip microprocessor (e.g., an Advanced RISC (Reduced Instruction Set Computer) Machine (ARM)), a special purpose microprocessor (e.g., a digital signal processor (DSP)), a graphics processing unit (GPU), a microcontroller, a programmable gate array, etc. The processor 801 may be referred to as a central processing unit (CPU). Although just a single processor 801 is shown in the computer system 800 of FIG. 8, in an alternative configuration, a combination of processors (e.g., an ARM and DSP) could be used.

The computer system 800 also includes memory 803 in electronic communication with the processor 801. The memory 803 may be any electronic component capable of storing electronic information. For example, the memory 803 may be embodied as random access memory (RAM), read-only memory (ROM), magnetic disk storage mediums, optical storage mediums, flash memory devices in RAM, on-board memory included with the processor, erasable programmable read-only memory (EPROM), electrically erasable programmable read-only memory (EEPROM) memory, registers, and so forth, including combinations thereof.

Instructions 805 and data 807 may be stored in the memory 803. The instructions 805 may be executable by the processor 801 to implement some or all of the functionality disclosed herein. Executing the instructions 805 may involve the use of the data 807 that is stored in the memory 803. Any of the various examples of modules and components described herein may be implemented, partially or wholly, as instructions 805 stored in memory 803 and executed by the processor 801. Any of the various examples of data described herein may be among the data 807 that is stored in memory 803 and used during execution of the instructions 805 by the processor 801.

A computer system 800 may also include one or more communication interfaces 809 for communicating with other electronic devices. The communication interface(s) 809 may be based on wired communication technology, wireless communication technology, or both. Some examples of communication interfaces 809 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 800 may also include one or more input devices 811 and one or more output devices 813. Some examples of input devices 811 include a keyboard, mouse, microphone, remote control device, button, joystick, trackball, touchpad, and lightpen. Some examples of output devices 813 include a speaker and a printer. One specific type of output device that is typically included in a computer system 800 is a display device 815. Display devices 815 used with embodiments disclosed herein may utilize any suitable image projection technology, such as liquid crystal display (LCD), light-emitting diode (LED), gas plasma, electroluminescence, or the like. A display controller 817 may also be provided, for converting data 807 stored in the memory 803 into text, graphics, and/or moving images (as appropriate) shown on the display device 815.

The various components of the computer system 800 may be coupled together by one or more buses, which may include a power bus, a control signal bus, a status signal bus, a data bus, etc. For the sake of clarity, the various buses are illustrated in FIG. 8 as a bus system 819.

In some implementations, the various components of the computer system 800 are implemented as one device. For example, the various components of the computer system 800 are implemented in a mobile phone or tablet. Another example includes the various components of the computer system 800 implemented in a personal computer. Another example includes the various components of the computer system 800 implemented in the cloud. Another example includes the various components of the computer system 800 implemented on an edge device.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a clustering model, a regression model, a language model, an object detection model, a probabilistic graphical model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, a datastore, or another data structure), ascertaining and the like. Also, “determining” can include receiving (e.g., receiving information), accessing (e.g., accessing data in a memory) and the like. Also, “determining” can include resolving, selecting, choosing, establishing, predicting, inferring, and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

1. A method comprising:
learning, by a neural network, an initial manifold over a dataset in response to the neural network performing manifold learning using a first loss function over the dataset;
generating, by the neural network, samples in response to the neural network performing manifold sampling over the initial manifold;
identifying a sample from the samples;
including the sample in a second loss function;
learning, by the neural network, a second manifold over the dataset in response to the neural network performing manifold learning using the second loss function over the dataset; and
generating, using the neural network, new samples in response to the neural network performing the manifold sampling over the second manifold.

2. The method of claim 1, wherein the initial manifold is a function of the first loss function versus the dataset and the second manifold is a function of the second loss function versus the dataset.

3. The method of claim 1, wherein the sample is an unwanted output of the neural network.

4. The method of claim 1, wherein the second loss function increases a loss for the sample decreasing a probability that the neural network generates the new samples using the sample.

5. The method of claim 1, wherein the second manifold increases a trench at an input data point in the dataset on the second manifold increasing a probability that the neural network generates the new samples from a region surrounding the trench, and
wherein the second loss function increases a loss of the sample and removes the sample from the region surrounding the trench in the second manifold.

6. The method of claim 5, wherein generating the new samples occurs in the region surrounding trench at the input data point.

7. The method of claim 1, wherein a plurality of input data points are identified in the dataset and the second manifold increases trenches in the second manifold, where each trench corresponds to an input data point of the plurality of data points.

8. The method of claim 7, wherein the trenches increase a probability that the neural network generates the new samples from regions surrounding the trenches.

9. The method of claim 7, wherein the second loss function increases a loss of the sample and removes the sample from regions surrounding the trenches, reducing a probability that the neural network generates the new samples from the sample.

10. The method of claim 1, wherein the sample is in a region a distance from samples coming from an underlying distribution of input data.

11. The method of claim 10, wherein as the distance increases from input data, samples generated by the neural network are out of distribution samples.

12. The method of claim 10, wherein the new samples are closer in distance to the input data as compared to the sample identified in the region.

13. The method of claim 1, further comprising:
identifying a set of samples from the samples; and
including the set of samples in the second loss function, wherein the second loss function increases the loss for each sample of the set of samples reducing a probability that the neural network generates the new samples from the sample.

14. The method of claim 1, wherein the manifold is a function of the first loss function versus the dataset.

15. The method of claim 1, wherein the neural network learns a probability distribution over the dataset.

16. The method of claim 1, wherein the manifold learning and the manifold sampling occurs in dimensions higher than one dimension.

17. A device comprising:
a memory to store data and instructions; and
a processor operable to communicate with the memory, wherein the processor is operable to:
learn, by a neural network, an initial manifold over a dataset in response to the neural network performing, using a first loss function, manifold learning over a dataset;
generate, by the neural network, samples in response to the neural network performing manifold sampling over the initial manifold;
identify a sample from the samples;
include the sample in a second loss function;
learn, by the neural network, a second manifold over the dataset in response to the neural network performing, using the second loss function, the manifold learning over the dataset; and
generate, using the neural network, new samples in response to the neural network performing the manifold sampling over the second manifold.

18. The device of claim 17, wherein the second manifold increases a trench at an input data point in the dataset on the second manifold increasing a probability that the neural network generates the new samples from a region surrounding the trench, and
wherein the second loss function increases a loss for the sample removing the sample from the trench and decreasing the probability that the neural network generates the new samples using the sample.

19. The device of claim 17, wherein the processor is further operable to:
identify a set of samples from the samples; and
include the set of samples in the second loss function, wherein the second loss function increases the loss for each sample of the set of samples reducing a probability that the neural network generates the new samples from the set of samples.

20. The device of claim 19, wherein a plurality of input data points are identified in the dataset and the second manifold increases trenches in the second manifold, where each trench corresponds to an input data point of the plurality of data points, and
wherein increasing the loss for each sample of the set of samples removes the set of samples from the trenches in the second manifold reducing the probability that the neural network generates the new samples from the set of samples.
